(19) United States
(12) Patent Application Publication
(10) Pub. No.: US 2003/0037326 A1
(43) Pub. Date: Feb. 20, 2003

(54) Method and system for installing staged programs on a destination computer using a reference system image

(76) Inventors: Ryan Burkhardt, Redmond, WA (US); Jason Cohen, Seatac, WA (US); Seetharaman Harikrishnan, Redmond, WA (US); Stephen Lodwick, Covington, WA (US); Donald McNamara, Woodinville, WA (US); Tom Yaryan, Seattle, WA (US)

Correspondence Address: SENNIGER POWERS LEAVITT AND ROEDEL, ONE METROPOLITAN SQUARE, 16TH FLOOR, ST LOUIS, MO, 63102, US

(21) Appl. No.: 09/922,616

(22) Filed: Aug. 6, 2001

(51) Int. Cl. G06F 9/445; G06F 9/44

(52) U.S. Cl. 717/178; 717/173

(57) ABSTRACT

A computerized method and system for installing programs on a destination computer. A reference computer having an operating system installed thereon stores one or more partially installed, staged programs and/or one or more fully installed programs. The operating system, installed programs, and staged programs define a reference image that is copied to a destination computer. With a configuration file script, a user selects at least one of the staged programs for installation on the destination computer. The script further directs an installation utility to attach the selected program to complete the installation thereof on the destination computer and to detach the remaining programs not selected for installation.

### TECHNICAL FIELD

The invention relates generally to configuring a computer for an end user and, particularly, to staging programs on a destination computer using a pre-configured reference system image to facilitate the installation of user-selected programs onto the destination computer by an original equipment manufacturer (OEM) or other system builder.

### BACKGROUND OF THE INVENTION

In general, a computer having merely an operating system by itself is not particularly attractive to the average computer user. The vast majority of end users desire a variety of accompanying programs, including applications and/or utilities. Moreover, different users typically desire different configurations of pre-installed programs when they buy new machines. For example, one end user may want application programs A, B, and C whereas another end user may want application programs B, D, and E. Unfortunately, original equipment manufacturers or system builders are limited in their ability to provide a wide array of pre-installed programs. A typical method of configuring a destination, or target, computer for an end user involves copying a master image to the memory of the target computer. If an OEM desires to offer a wide variety of programs in different combinations for purchase by the end user, it would be necessary to create and maintain a very large number of reference system images (e.g., several thousand) with the different combinations of available software applications. In the alternative, the OEM may be required to manually install a number of the programs desired by the end user. Also, extensive testing of the software is typically required for each combination of programs (including updates).

Original equipment manufacturers typically use a standard operating system setup program and then create working images. This is a one-time, up front investment. However, when software fixes or other updates become available, it is difficult to deploy the updates without having to go through the expensive, time consuming process of creating, testing, and re-validating a new working image.

Although known methods for installing programs vary from one OEM to another, all of these methods need improvement in terms of cost, time, and flexibility. A method and system of installing programs on a target computer is desired that allows use of a single reference, or master, image from which the programs are copied. Moreover, such method and system are desired to improve the OEM's ability to deploy updates and to automate the handling of re-boots during the installation process.

### SUMMARY OF THE INVENTION

The invention meets the above needs and overcomes the deficiencies of the prior art by providing an improved method and system of installing programs on a target computer to pre-configure the computer according to an end user's preferences. According to one aspect of the invention, the method and system permit creating a single reference image that can be copied to a number of target computers even though each computer is being built to order for a particular end user. After copying the reference image to the target computer, the invention beneficially permits incremental processing to complete the computer's final configuration by the original equipment manufacturer. This advantageously provides a dramatic reduction in the time it takes to produce customized machines, provides significant cost savings in maintaining the reference system image, and facilitates updating the operating system and other programs. Moreover, the improved method and system further provide a controllable environment in which the OEM can script the installation of programs on the target computer, including automating re-boots and the like.

Briefly described, a computerized method embodying aspects of the invention installs programs on a destination computer. The method includes staging one or more programs on a storage medium of the destination computer and selecting at least one of the staged programs for installation on the destination computer. The method further includes attaching the selected program to complete its installation on the destination computer.

Another embodiment of the invention is directed to a system for configuring a computer. The system includes a reference computer and a destination computer. The reference computer includes a storage medium having an operating system installed thereon and one or more programs staged thereon. The storage medium of the reference computer defines a reference image. The destination computer includes a storage medium and a processor. The reference image is copied to the storage medium of the destination computer. The system also includes a computer-readable medium having computer-executable instructions that identify at least one of the staged programs for installation on the destination computer. The destination computer's processor executes the instructions to attach the identified program to complete its installation on the destination computer.

Yet another embodiment of the invention is directed to a computer-readable medium having a data structure stored thereon. The data structure has a first data field including files associated with a plurality of staged programs. The programs are staged on the computer-readable medium for installation on a destination computer associated with the computer-readable medium. The data structure also has a second data field including a configuration script for directing the destination computer in performing one or more functions. The script is customizable for identifying at least one of the staged programs for installation on the destination computer.

Alternatively, the invention may comprise various other methods and apparatuses.

Other objects and features will be in part apparent and in part pointed out hereinafter.

### BRIEF DESCRIPTION OF THE DRAWINGS

FIG. 1 is a block diagram of a suitable computing system environment on which the invention may be implemented according to a preferred embodiment of the invention.

FIG. 2 is a block diagram illustrating an exemplary installation of an operating system and selected program(s) onto a computer system hard drive of the computing system environment of FIG. 1.

FIG. 3 is a flow chart illustrating an exemplary process flow for configuring the computer system hard drive of FIG. 2.

Corresponding reference characters indicate corresponding parts throughout the drawings.

### DETAILED DESCRIPTION OF THE INVENTION

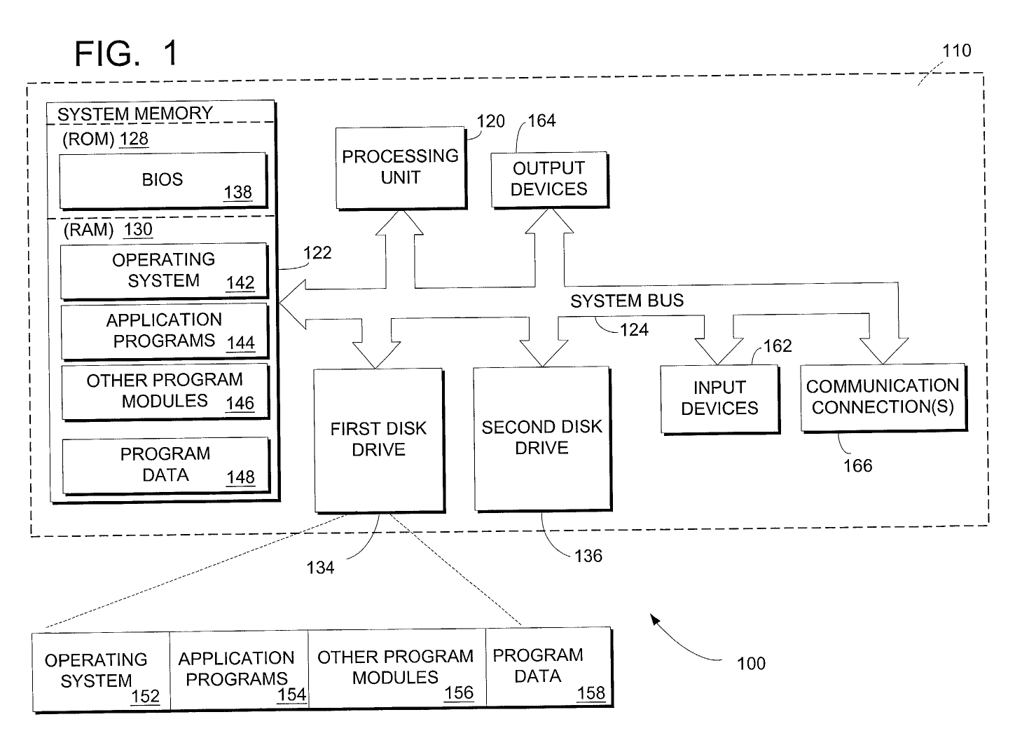

FIG. 1 illustrates one example of a suitable computing system environment 100 on which the invention may be implemented, including a general purpose computing device in the form of a computer 110. The computer 110 preferably has a processing unit 120 and a system memory 122. In the illustrated embodiment, a system bus 124 couples various system components including the system memory 122 to the processing unit 120. The system bus 124 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 110 typically has at least some form of computer readable media. Computer readable media, which include both volatile and nonvolatile media, removable and non-removable media, may be any available medium that can be accessed by computer 110. By way of example and not limitation, computer readable media comprise computer storage media and communication media. Computer storage media include both volatile and nonvolatile, removable and non-removable media implemented in any method or technology for storage of information such as computer readable instructions, data structures, program modules or other data. For example, computer storage media include RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium that can be used to store the desired information and that can accessed by computer 110. Communication media typically embody computer readable instructions, data structures, program modules, or other data in a modulated data signal such as a carrier wave or other transport mechanism and includes any information delivery media. Those skilled in the art are familiar with the modulated data signal, which has one or more of its characteristics set or changed in such a manner as to encode information in the signal. Wired media, such as a wired network or direct-wired connection, and wireless media, such as acoustic, RF, infrared, and other wireless media, are examples of communication media. Combinations of the any of the above are also included within the scope of computer readable media.

The system memory 122 preferably includes computer storage media in the form of removable and/or non-removable, volatile and/or nonvolatile memory. In the illustrated embodiment, system memory 122 includes read only memory (ROM) 128 and random access memory (RAM) 130. By way of example, FIG. 1 also illustrates a first disk drive 134 that reads from or writes to non-removable, nonvolatile magnetic media (e.g., a hard disk drive) and a second disk drive 136 that reads from or writes to a removable, nonvolatile magnetic or optical storage device (e.g., floppy disk, zip disk, CD-ROM, DVD, etc.). Other removable/non-removable, volatile/nonvolatile computer storage media that can be used in the exemplary operating environment 100 include, but are not limited to, magnetic tape cassettes, flash memory cards, digital video tape, solid state RAM, solid state ROM, and the like. The hard disk drive 134 is typically connected to system bus 124 through a non-removable memory interface (not shown). Similarly, the magnetic or optical disk drive 136 is typically connected to system bus 124 by a removable memory interface (not shown).

In a preferred embodiment, the present invention facilitates the installation of user-selected programs onto a destination, or target, computer (e.g., computer 110) by an original equipment manufacturer (OEM) or other system builder. Following this installation, ROM 128 typically stores a basic input/output system (BIOS) 138, containing the basic routines that help to transfer information between elements within computer 110, such as during start-up. RAM 130 typically contains data and/or program modules that are immediately accessible to and/or presently being operated on by processing unit 120. By way of example, and not limitation, FIG. 1 illustrates operating system 142, application programs 144, other program modules 146, and program data 148 contained in RAM 130 during operation of computer 110.

The drives 134, 136 and their associated computer storage media discussed above and illustrated in FIG. 1, provide storage of computer readable instructions, data structures, program modules, and other data for computer 110. In FIG. 1, for example, hard disk drive 134 is illustrated as storing operating system 152, application programs 154, other program modules 156, and program data 158. Note that these components can either be the same as or different from operating system 142, application programs 144, other program modules 146, and program data 148 stored in RAM 130. Operating system 152, application programs 154, other program modules 156, and program data 158 are given different numbers here to illustrate that, at a minimum, they are different copies. As will be described in detail below, the present invention relates to the installation of these components on hard disk drive 134 (or other storage media of the target computer).

A user may enter commands and information into computer 110 through one or more input devices 162, such as a keyboard, pointing device (e.g., a mouse, trackball, pen, or touch pad), microphone, joystick, game pad, satellite dish, scanner, or the like.

The input devices 162 are often connected to processing unit 120 through a user input interface (not shown) that is coupled to system bus 124, but may be connected by other interface and bus structures, such as a parallel port, game port or a universal serial bus (USB). One or more output devices 164, such as a monitor, printer, speakers, or the like, may be connected through an appropriate video or output peripheral interface (not shown). All of these devices are well known in the art and need not be discussed at length here.

The computer 110 may also contain communications connection(s) 166 that allow computer 110 to communicate with other devices. Communications connection(s) 166 is an example of communication media. Computer 110 may operate in a networked environment using logical connections to one or more remote computers (not shown), such as a remote personal computer, server, router, network PC, peer device, or other common network node. Such networking environments are commonplace in offices, enterprise-wide computer networks, intranets, and global computer networks (e.g., the Internet).

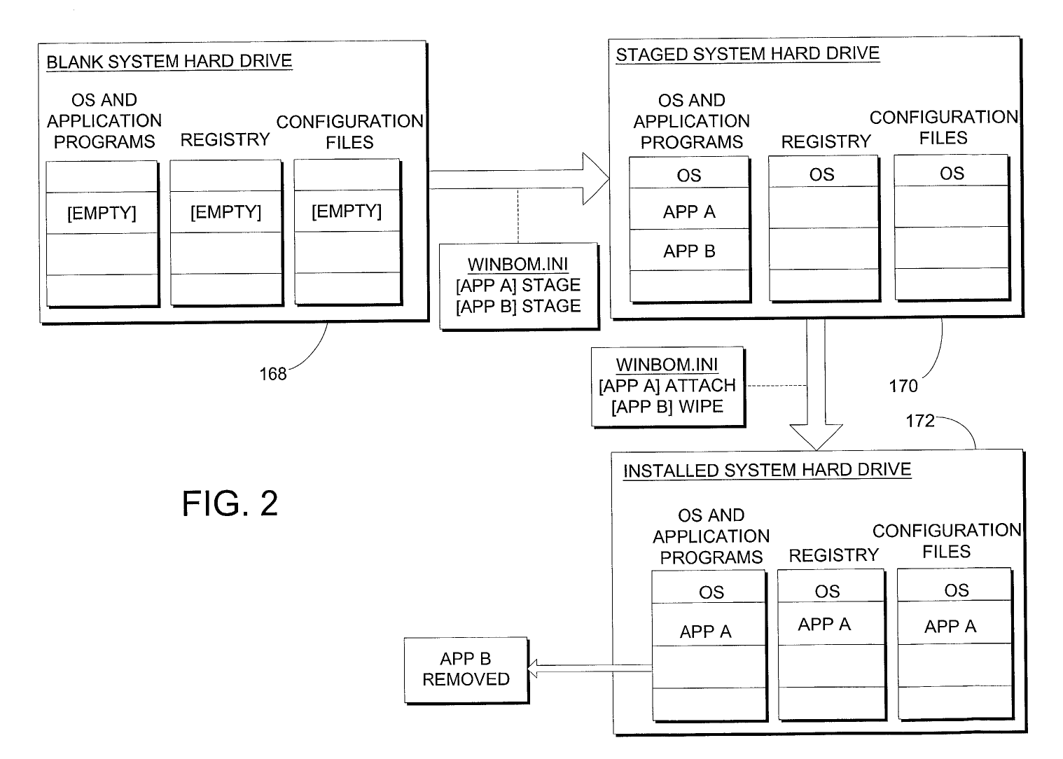

Referring now to FIG. 2, a preferred embodiment of the invention permits the OEM to create a single reference system image that includes a fully installed operating system, full installations of the programs that are most often selected, and/or “staged” installations of the programs that can be fully installed later. FIG. 2 shows a blank system hard drive 168, such as the hard drive 134 of computer 110 prior to installation or storage of OS 152, application programs 154, other program modules 156, and/or program data 158. To indicate that no application programs are installed on blank hard drive 168 at this point in the process, portions of the drive labeled OS and application programs, registry, and configuration files are shown to be empty. The OEM preferably creates a reference on blank system hard drive 168 for use in building one or more destination computers (e.g., computer 110) for ultimate distribution to end users.

Original equipment manufacturers typically execute unattended setup programs for installing and configuring operating systems and other applications. These setup programs use an answer file (e.g., UNATTEND.TXT) to specify instructions for an unattended, “hands free,” or quiet setup. In one embodiment of the invention, the OEM adds a key to the UNATTEND.TXT file, for example, indicating that the installation is for a reference system. This sets up the machine so that it automatically installs additional applications/utilities, etc. after the core operating system has been installed. As described below, a configuration script preferably controls the order of these additional installs.

As an alternative to fully installing a program, the OEM can set up the reference system so that it stages (i.e., copies the needed installation files locally) the program so that the program is available in the reference image for later installation. Staging a program involves copying the needed installation files to a target machine but not fully integrating the staged program with the operating system. In other words, a staged installation of a program can be accomplished by indicating the name of the setup file and the location of the setup files along with a desired destination. As an example, a staged system hard drive 170 shown in FIG. 2 includes application programs A and B partially installed, or staged, on blank system hard drive 168. In this example, the OEM or system builder first executes an installation utility (e.g., FACTORY.EXE) to install the OS, as indicated by corresponding registry and configuration file entries in hard drive 170. The frilly installed OS and staged application programs A and B of the staged system hard drive 170 define the pre-configured reference system. It is to be understood that the pre-configured reference system may include other staged programs, including application programs, and/or filly installed programs that are not illustrated for simplicity.

The reference system preferably includes one or more programs that the OEM expects to include in the final configuration of the target computer. These programs, referred to as “high attach rate” programs, may be either filly installed or staged in the reference system. For example, a large percentage of an OEM's customers may desire one or more application programs installed on their computers from a group of word processing, spreadsheet, money management, and other application programs. For this reason, the OEM may wish to stage or install these programs on the reference system to facilitate their installation for the various end users. In this manner, the present invention allows creating one reference image of the operating system along with pre-installed or staged high attach rate programs. The staging of a program, as opposed to fully installing it, requires less memory and, thus, a greater number of high attach rate programs may be available in the reference image for a given storage space to provide a greater variety of final system configurations. Moreover, staging may save the OEM time if it chooses to install a particular application at a later time because it does not need to, for example, copy the application installation files over a network or from a CD, or run the installation over the network. For these reasons, either staging or a combination of staging and pre-installation of high attach rate programs may be preferred over only pre-installation under certain conditions. It is to be understood that the OEM can create a reference system without the use of scripts and staging using known methods.

According to a preferred embodiment of the invention, computer 110 operates in an environment in which scripts are used to create the reference system image. A configuration script (e.g., a text file such as WINBOM.INI) preferably directs the installation utility FACTORY.EXE and controls the order in which programs are installed or staged on the reference system and re-boots the reference system as necessary. In this manner, staged system hard drive 170 is established for use in pre-configuring one or more target or destination machines. It is to be understood that the script need not be in the form of a text file in a .INI file format but may be, for example, an XML file or even a binary format.

After defining the reference system, the OEM then replicates its image, including the staged programs, onto one or more target computers. In FIG. 2, staged system hard drive 170 represents the reference system, which is preferably implemented on a computer of the type indicated at reference character 110. For simplicity, staged system hard drive 170 also represents the hard drive of a staged target computer, also implemented on a computer such as computer 110, after the reference image has been copied to its destination. Those skilled in the art are familiar with hardware and software level imaging technologies for creating the reference image. Moreover, even at a software level, straight file copy scripts with some boot sector manipulation (e.g., FDISK or FORMAT tools) may be used to copy the reference system image.

After copying the reference system image to the destination computer, the OEM uses an installation utility (e.g., FACTORY.EXE) to “attach” the staged programs that were selected by the end user and to “detach” the staged programs that were not selected by the user. In addition, FACTORY.EXE preferably uninstalls the fully installed high attach rate programs that were not selected by the user for the final configuration. This is particularly beneficial when building computers to order. The invention employs a script to determine which programs are to be attached, detached, or uninstalled on the target machine and to control the order in which the staged programs are attached, detached, or uninstalled on the target machine. In addition, the script can instruct FACTORY.EXE to run the setup programs to install other programs from a separate location (e.g., over a network) even if these other programs were not previously staged. The script also re-boots the target computer automatically as necessary and can be used to prevent conflicts when different programs depend on common or similar files. Moreover, use of the script allows unnecessary steps (e.g., checking disk space for new installations) to be eliminated from the set up. Those skilled in the art are familiar with many ways for the OEM to identify and incorporate end user selections into the script.

Attaching the selected, staged programs involves incremental processing to fully install the software (e.g., final placement of registry entries, desktop shortcuts, shared files, etc.). Detaching, also referred to as “wiping,” deletes the files associated with the non-selected, staged programs and not otherwise needed by any of the selected programs. In the alternative, detaching also involves disabling the non-selected files via keys in the script. For those programs that were fully installed in the reference system, uninstallation includes deleting the relevant files and removing the integration with the OS. Thus, the OEM need not run the original, time-consuming setup programs on each target machine (e.g., the installation time for a particular application program may drop from a time of about 10 minutes to an incremental processing time of about one minute).

In the example of FIG. 2, an installed system hard drive 172 representing the end user's desired final configuration includes a fully installed OS and fully installed application program A. As directed by the configuration script (e.g., WINBOM.INI), staged application program B was detached or wiped from the installed system hard drive 172. Advantageously, the incremental processing performed at this time may include adding updates (e.g., a QFE software fix) and other user requested programs. It is to be understood that the present invention relates to the staging and installation of computer programs, including application programs, utilities, updates, and the like.

Further to the example of FIG. 2, the reference system image (i.e., drive 170) preferably contains a template script file WINBOM.GEN that includes information on each program pre-install section that produced a staged program. The OEM modifies WINBOM.GEN on the target machine to create WINBOM.INI, which directs FACTORY.EXE as to which staged programs are to be attached or detached on the computer and in what order. The template WINBOM.GEN is useful in determining the values of the keys of the WINBOM.INI file on the target machine for either an attach or wipe (see APPENDIX A). On each boot until the WINBOM.INI file instructs FACTORY.EXE that it has reached the last configuration step, the machine, including the operating system, is re-configured. After the last configuration step, the OEM can seal the machine for shipping to the end user. Advantageously, pre-configuring a plurality of destination computers in the manner described herein does not require the OEM to run the original setup programs for the OS and/or initial program installs on each machine. This removes a bottleneck in the process and significantly speeds configuration times. The resultant configuration is represented by installed system hard drive 172.

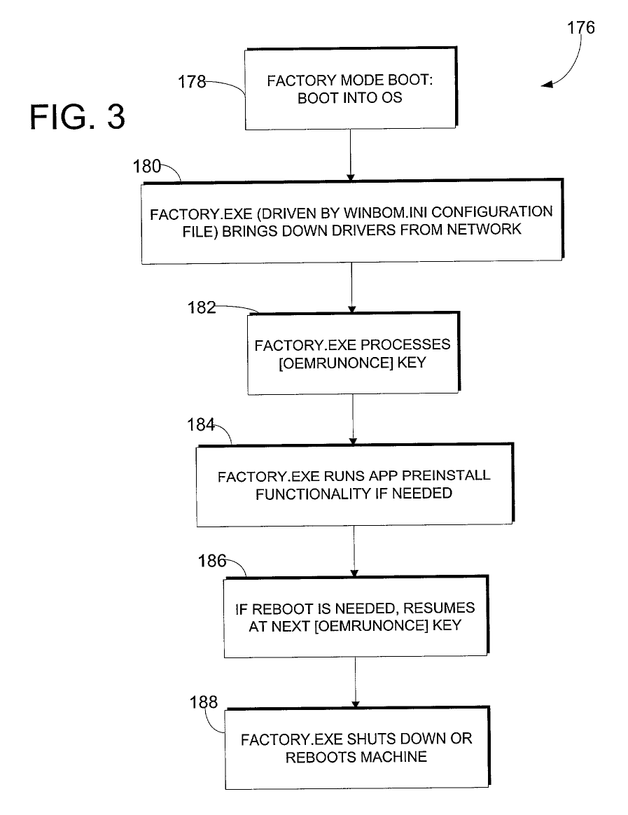

In FIG. 3, a flow diagram 176 illustrates an exemplary process for pre-configuring a target computer for an end user using a reference system image copied to the target computer. The flow diagram 176 refers to the process of configuring the staged system hard drive 170 to result in the installed system hard drive 172, which represents the end user's desired final configuration.

At step 178, the OEM first boots the OS of the destination machine on the factory floor, for example. The installation begins at step 180 when the target machine runs an installation program FACTORY.EXE. As described above, a configuration file script WINBOM.INI directs the subject matter and order of the FACTORY.EXE installation. The target machine is preferably connected to a network and, at step 180, FACTORY.EXE downloads and installs the various device drivers needed by the target machine. The device drivers are preferably downloaded for installation instead of being staged because updated drivers are often released after the reference image has been created. As such, unneeded drivers are not on the local system, which saves space on the image and, thus, saves network time to download the image. Also, the image need not be matched with particular hardware. Proceeding to step 182, FACTORY.EXE processes the first OEMRUNONCE key. In this example, OEMRUNONCE is a tool for designating particular commands to be run the first time the computer is turned on. Advantageously, OEMRUNONCE permits ordering, i.e., the OEM can instruct the computer to execute the OEMRUNONCE commands in a particular order to prevent conflicts and the like between the commanded operations. The FACTORY.EXE program then runs the program pre-installation functionality, at step 184, to attach and/or detach programs selected by the end user for the final system configuration. As described above, the WINBOM.INI script drives the FACTORY.EXE utility to control the order in which programs are installed and re-boots the reference system if necessary at step 186. The FACTORY.EXE installation utility also proceeds to the next OEMRUNONCE key at step 186. In this embodiment of the invention, the target computer completes the installation operation at step 188 by executing FACTORY.EXE to either shut down or re-boot the system as needed.

The following are example scripts implemented in the operating system of computer 110 according to a preferred embodiment of the present invention:

Program Pre-install:

[OEMRunOnce] (lists executables to be run from the script)

App1,c:\apps\1\setup.exe

App2,MSOffice,MSI (takes advantage of this program pre-install functionality)

MyApp,c:\apps\3\setup.exe

REBOOT

App3,c:\apps\8\install.exe

Staging:

[MSOffice]

InstallType=Stage (indicates that the program is being staged)

SourcePath=\\opkhal\app\office (network location of source files to copy locally)

TargetPath=%windir%\OEM\apps\office (location to copy install files locally)

SetupFile=setup.msi (which executable to call when installtype=Stage)

CmdLine=/q/m (any extra command line arguments to add to the installer)

Reboot=NO (tells OS to not reboot after staging)

Detaching:

[MSOffice]

InstallType=Detach (indicates that program is being wiped)

SourcePath=v:\opkhal\app\office (network location of source files to copy locally)

TargetPath=%windir%\OEM\apps\office (location to delete install files locally)

SetupFile=setup.msi (which executable to call when installtype=Detach)

CmdLine=/q/m (any extra command line arguments to add to the installer)

Reboot=NO (tells OS to not re-boot after wiping)

Attaching:

[MSOffice]

InstallType=Attach (indicates that program is being attached)

SourcePath=\\opkhal\app\office (network location of source files to copy locally)

TargetPath=%windir%\OEM\apps\office (location to copy install files locally)

SetupFile=setup.msi (which executable to call when installtype=Attach)

CmdLine=/q/m (any extra command line arguments to add to the installer)

Reboot=YES (tells OS to re-boot after attaching)

As described above, a utility such as FACTORY.EXE preferably executes the script, referred to as a WINBOM.INI file, for carrying out the program installation function. APPENDIX A provides a description of the keys of a WINBOM.INI file according to one preferred embodiment of the invention.

Although described in connection with exemplary computing system environment 100, including computer 110, the invention is operational with numerous other general purpose or special purpose computing system environments or configurations. The computing system environment 100 is not intended to suggest any limitation as to the scope of use or functionality of the invention. Moreover, computing system environment 100 should not be interpreted as having any dependency or requirement relating to any one or combination of components illustrated in the exemplary operating environment 100. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, executed by one or more computers or other devices. Generally, program modules include, but are not limited to, routines, programs, objects, components, and data structures that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

In view of the above, it will be seen that the several objects of the invention are achieved and other advantageous results attained.

As various changes could be made in the above constructions and methods without departing from the scope of the invention, it is intended that all matter contained in the above description and shown in the accompanying drawings shall be interpreted as illustrative and not in a limiting sense.

### Appendix A

The following provides comments with respect to an example WINBOM.INI configuration script:

WINBOM.INI:

[Factory]

.

.

.

[PnPDriverUpdate]

.

.

.

[AppPreInstall]

App1=Office

App2=Works

App3=Acrobat

[Office]

InstallType=[1|2|3]

InstallTechnology=[1||2|3]

SetupFile=[foo.msi|setup.exe|generic.exe| . . . ]

Image=[c:\office\CD1|c:\office|c:\images\acrobat| . . . ]

Destination=[c:\images\office c:\setupbits\acrobat| . . . ]

Log=[c:\temp\foo.log| . . . ]

CmdLine=[-s -r -f|/f foo.log| . . . ]

Transform=[c:\transforms\foo.mst, c:\transforms\bar.mst| . . . ]

[Works]

.

.

.

[Acrobat]

.

.

.

EOF

App#: The “App#” key is arbitrary (the code looks for some key that differentiates one section from the other sections). This section is mainly used to enforce a particular installation order and indicate the name of the section that includes the additional information for that particular install. This is the section referred to by the program to be installed first (in this example, Appl under [AppPreInstall]).

InstallType=[1|2|3]: The InstallType key can assume a value of 1, 2 or 3 where each value has the following effect:

InstallType=1 indicates the user's desire to “stage” the installation of this program. Although this is typically performed on the reference machine when staging the program to either be wiped or attached on the target machine, there is no way to tell whether the subject is the target or reference. For simplicity and ease of use, there are no other flags or command line arguments passed to FACTORY.EXE that tell it the reference machine is being prepared. If InstallType=1, FACTORY.EXE just performs a staging of the program consistent with the other information provided in this section. Note: staging is usually performed on a machine after the user has logged onto the network.

InstallType=2 indicates the user's desire to “attach” the program. This prompts FACTORY.EXE to locate the value of the SetupFile key (in this same section) and initiate a FASTOEM install on the MSI for the SetupFile key. In the case of installation programs, such as those sold by Wise Solutions, Inc. or InstallShield Software Corporation, this key prompts the execution of the indicated SETUP.EXE file.

InstallType=3 indicates the user's desire to “wipe” the program. This prompts FACTORY.EXE to locate the value of the Image key (also located in the same section) and delete the directory and all recursive sub-directories for the Image key.

InstallTechnology=[1|2|3]: The InstallTechnology key can assume a value of 1, 2 or 3 where each value has the following effect:

InstallTechnology=1 indicates the installation procedure will rely on MSI installation technology and infers that the type of SetupFile is an .MSI file.

InstallTechnology=2 indicates the installation procedure will rely on Wise Solutions, Inc. installation technology and indicates the type of SetupFile is an .EXE file.

InstallTechnology=3 indicates the installation procedure will rely on InstallShield Software Corporation installation technology and the type of SetupFile is an .EXE file. Note: FACTORY.EXE differentiates between Wise Solutions, Inc. and InstallShield Software Corporation installs in order to know what type of command line arguments to pass into SETUP.EXE and to know what type of INF/INI files this particular SETUP.EXE uses.

InstallTechnology=4 indicates the installation technology is unknown from the perspective of FACTORY.EXE and setup will consist of running a single executable file indicated with the SetupFile key. Note: It is the responsibility of the author of the WINBOM.INI to guarantee that this process is quiet, as FACTORY.EXE will be unable to determine this.

SetupFile=[foo.msi|setup.exe|generic.exe| . . . ]: The SetupFile key directs FACTORY.EXE to the location of the file necessary to perform an installation (of any type).

In the event of a staging installation using Wise Solutions, Inc. or InstallShield Software Corporation programs, for example, this key has no meaning for FACTORY.EXE as the value of the Image key indicates the location of the required setup files.

In the context of an MSI staging installation, however, FACTORY.EXE either evokes an administration installation on the package defined by this key (if no custom actions are present in the admin install execute sequence) or performs a recursive descent copy of the directory specified by the Image key.

In the context of attaching the program using MSI technology, a FASTOEM install is initiated on the value of SetupFile.

On the other hand, in the context of a Wise Solutions, Inc. or InstallShield Software Corporation attach, the process referred to by SetupFile is evoked after having supplied the appropriate directives via command line arguments or external INF/INI files that SetupFile knows to look for.

In the event WINBOM.INI specifies transform files, the files are applied to the package defined by this key either after staging or before attaching (depending on the value of InstallType).

This key has no meaning in the case of a wipe and may be omitted.

Image=[c:\office\CD1 c:\office|c:\images\acrobat| . . . ]: The Image key corresponds to the fully qualified path of the directory where the setup files reside. This directory assumes a variety of meanings under various contexts.

In the context of an MSI staging installation, the value of the Image key is the source of the files that are required in order to attach the program, or that will be removed if the program is later wiped from the target machine.

In the context of an MSI attach, the value of the Image key indicates the directory containing the files to remove after the installation is complete in order to return the machine to a “clean” state (i.e. no “left-over” files will remain that are not necessary for normal operation of the particular program).

In the context of an MSI wipe, the value of Image is the directory to be removed.

In the context of Wise Solutions, Inc./InstallShield Software Corporation staging, the value of this key is again the source of the directory containing the setup files that will ultimately be either deleted (wiped) or attached.

In the context of Wise Solutions, Inc./InstallShield Software Corporation attaching, this directory is removed after installation is complete to, again, return the machine to a “clean” state.

In the context of Wise Solutions, Inc./InstallShield Software Corporation wiping, this directory is simply removed.

If no Image key is specified during an attach, no files are removed after installation.

The Image key must refer to a directory.

Destination=[c:\images\office|c:\setupbits\acrobat| . . . ]: The Destination key is necessary only in the context of staging the installation of a program and is ignored (and can be omitted) during an attach or wipe.

In the event of staging an installation using MSI, Destination tells FACTORY.EXE where to place the required installation files, either by evoking a direct Xcopy of the bits from Image to Destination or by using MSI in admin install mode to copy only the essential files for the selected set of features.

In the context of Wise Solutions, Inc./InstallShield Software Corporation staging, Destination refers to the directory where the Image directory is copied.

Log=[c:\temp\foo.log| . . . ]: The Log key indicates the desired location and name of a log file generated by an MSI installer package file, Wise Solutions, Inc. installer, or InstallShield Software Corporation installer (depending on which engine is used during the install). This log is completely independent of FACTERR.LOG and FACTORY.LOG and contains only that information supplied by the particular installation technology. This key is fully optional. In the absence of this key, no additional log file is generated.

CmdLine=[-s -r -f|/f foo.log| . . . ]: The CmdLine key can be used to specify any additional command line options to pass to the installation program. This key is typically used in the context of attaching a program and is also optional.

Transform=[c:\transforms\foo.mst, c:\transforms\bar.mst| . . . ]: The Transform key can be used to specify a single transform that should be applied to an installation package and is beneficial when using MSI technology. This key can be used during either a stage or an attach. The SetupFile key must be populated with a valid MSI package for this functionality to behave correctly. Note: A transform is applied at stage time if an admin install is taking place (no custom actions in the admin execute sequence). Otherwise, the transform program is postponed until the attach stage.

To summarize:

A. Staging

1. MSI

a. Determine if an admin install can be performed on the value of SetupFile. If this is the case (there are no custom actions present in the admin install sequence), perform the admin install indicating to MSI that the desired destination of the files is the value of Destination.

b. If this is not the case and an admin install cannot be performed, perform an XCopy of the files/directories in Image to Destination.

c. Apply any patches indicated by the Transform key.

2. Wise Solutions, Inc./InstallShield Software Corporation/Generic

a. Perform an XCopy of the files/directories in Image to Destination.

B. Attaching

1. MSI

a. Ask the MSI installer to install the package referred to by SetupFile in FASTOEM mode. Once installation is complete, delete the Image for purposes of “cleaning-up” the system.

2. Wise Solutions, Inc./InstallShield Software Corporation

a. Execute the SETUP.EXE file with the appropriate command line arguments that initiate a quiet installation.

b. Note: In the case of InstallShield Software Corporation installation software, it is the author's responsibility to supply a valid ISS file in the same directory as the setup executable in order to guarantee silent installation of the package (these can be generated by supplying the -r switch to a normal InstallShield Software Corporation SETUP.EXE).

3. Generic

a. Execute the SETUP.EXE file. Note: Cannot guarantee this process is quiet. It is the responsibility of the author of the WINBOM.INI file to guarantee this is the case.

C. Wipe

1. In all cases, delete the directory referred to by the Image key.

1. A computerized method of installing programs on a destination computer, said method comprising:
staging one or more programs on a storage medium of the destination computer;
selecting at least one of the staged programs for installation on the destination computer; and
attaching the selected program to complete the installation thereof on the destination computer.

2. The method of claim 1 further comprising detaching any of the programs not selected for installation on the destination computer.

3. The method of claim 1 further comprising defining a reference system, said reference system comprising a computer that has an operating system installed thereon and the one or more programs staged thereon, and wherein staging the programs includes copying an image of the reference system to the storage medium of the destination computer.

4. The method of claim 3 wherein defining the reference system includes performing one or more functions on the reference system computer according to a customizable script.

5. The method of claim 4 wherein the script is a text-based configuration file.

6. The method of claim 4 wherein the script identifies a location where files associated with the staged programs are to be copied.

7. The method of claim 4 wherein the script defines an order in which the programs are to be staged.

8. The method of claim 1 wherein the destination computer has a registry for storing configuration data and wherein staging the programs includes copying files associated with the programs to the storage medium of the destination computer without storing configuration data associated with the programs in the registry.

9. The method of claim 8 wherein attaching the selected programs includes storing configuration data associated with the selected programs in the registry.

10. The method of claim 1 wherein attaching the selected programs includes performing one or more functions on the destination computer according to a customizable script.

11. The method of claim 10 wherein the script is a text-based configuration file.

12. The method of claim 10 wherein the script identifies which of the staged programs are to be attached and which of the staged programs are to be detached.

13. The method of claim 10 wherein the script defines an order in which the selected programs are to be attached.

14. The method of claim 1 wherein attaching the selected programs includes executing an installation command routine according to the script.

15. The method of claim 1 wherein the programs include either application programs, utility programs, or both.

16. The method of claim 1 further comprising:
executing a first installation utility on a reference computer;
installing an operating system on the reference computer using the installation utility;
controlling the first installation utility according to a first configuration script to stage the one or more programs on a storage medium of the reference computer;
defining a reference image of the storage medium of the reference computer having the operating system installed thereon and the one or more programs staged thereon; and
copying the reference image to the destination computer.

17. The method of claim 16 further comprising:
executing a second installation utility on the destination computer; and
controlling the second installation utility according to a second configuration script to attach the selected program on the destination computer.

18. A computer readable medium having computer-executable instructions for performing the method recited in claim 1.

19. A system for configuring a computer comprising:
a reference computer including a storage medium, said storage medium of the reference computer having an operating system installed thereon and one or more programs staged thereon, said storage medium of the reference computer defining a reference image;
a destination computer including a storage medium and a processor, said reference image being copied to the storage medium of the destination computer; and
a computer-readable medium having computer-executable instructions identifying at least one of the staged programs for installation on the destination computer, said processor of the destination computer executing the instructions to attach the identified program to complete the installation thereof on the destination computer.

20. The system of claim 19 wherein the computer-readable medium includes computer-executable instructions for detaching any of the programs not selected for installation on the destination computer.

21. The system of claim 19 wherein the computer-readable medium comprises a customizable script.

22. The system of claim 21 wherein the script is a text-based configuration file.

23. The system of claim 21 wherein the script defines an order in which the programs are to be staged on the reference computer.

24. The system of claim 21 wherein the script identifies which of the staged programs are to be attached and which of the staged programs are to be detached.

25. The system of claim 21 wherein the computer-readable medium further comprises an installation command routine and wherein the processor of the destination computer executes the command routine according to the script.

26. The system of claim 19 wherein the destination computer has a registry for storing configuration data and wherein files associated with the staged programs are copied to the storage medium of the destination computer without storing configuration data associated with the staged programs in the registry.

27. The system of claim 26 wherein the registry of the storage medium of the destination computer stores configuration data associated with the identified program after the identified program has been attached.

28. The system of claim 19 wherein the programs include either application programs, utility programs, or both.

29. The system of claim 19 wherein the computer-readable medium has computer-executable instructions for:
executing a first installation utility on the reference computer;
installing the operating system on the reference computer using the installation utility;
controlling the first installation utility according to a first configuration script to stage the one or more programs on the storage medium of the reference computer;
defining the reference image of the storage medium of the reference computer having the operating system installed thereon and the one or more programs staged thereon; and
copying the reference image to the destination computer.

30. The system of claim 29 wherein the computer readable medium has further computer-executable instructions for:
executing a second installation utility on the destination computer; and
controlling the second installation utility according to a second configuration script to attach the identified program on the destination computer.

31. A computer-readable medium having stored thereon a data structure comprising:
a first data field including files associated with a plurality of staged programs, said programs being staged on the computer-readable medium for installation on a destination computer associated with the computer-readable medium; and
a second data field including a configuration script for directing the destination computer in performing one or more functions, said script being customizable for identifying at least one of the staged programs for installation on the destination computer.
